(19) United States
(12) Patent Application Publication
(10) Pub. No.: US 2009/0038511 A1
(43) Pub. Date: Feb. 12, 2009

(54) CARRIAGEWAY AND GROUND SURFACING FOR CARRIAGEWAYS

(75) Inventors: Roger Hartenburg, Lampertheim (DE); Berthold Lahl, Kirchheim (DE); Lothar Kromer, Grunwald (DE)

Correspondence Address: OSLER, HOSKIN & HARCOURT LLP (OTHER), 1000 DE LA GAUCHETIERE STREET WEST, SUITE 2100, MONTREAL, QC, H3B-4W5, CA

(73) Assignee: TERRAELAST AG, Sauerlach (DE)

(21) Appl. No.: 11/908,941

(22) PCT Filed: Mar. 18, 2005
(86) PCT No.: PCT/DE2005/000505

§ 371 Date: Jun. 17, 2008

(51) Int. Cl. C04B 28/00

(52) U.S. Cl. 106/287.34

(57) ABSTRACT

The superstructure (2) of a carriageway is embodied in a multi-layer manner and comprises, as the surface and first layer (3), a hardened compound consisting of glass particles, an organic adhesive, and a polyurethane adhesive. The glass particles are a mixture of glass beads and broken glass. The light-positive property of the glass particles of the compound enables the colour of the adhesive to be continuously transmitted from glass particle to glass particle up to the surface, such that the colour can also be seen when the glass particles are worn down or the adhesive is soiled or becomes turbid on the surface side. In this way, permanent colour stability is ensured even when the surface is worn down. The surface thus maintains the aesthetically pleasing or indicative colour thereof.

The invention relates to a ground surfacing for carriageways and to methods for application onto a foundation. The ground surfacing exhibits a multilayered structure with a superstructure and a substructure, the superstructure of the ground surfacing being a combination of compacted, solid aggregates and organic adhesives. The invention further relates to a carriageway with a superstructure and a substructure that have been applied on a foundation. Ground surfacings and carriageways of such a type are known from DE 196 05 990 A1 and DE 197 33 588 A1.

Particular demands are made in this connection with regard to constructional properties. These relate to the behaviour in the event of humidity, resistance to pests, acoustic properties, response to chemical influences and to fire. The durability of a ground plays a major role as the most important demand, with properties such as compressive strength, tensile bending strength, abrasion resistance in relation to grinding, rolling, shock and impact, resistance to impression, constituting significant constructional parameters.

A disadvantageous aspect of asphalt surfacings that are produced from a mixture of bitumen and gravel is their sensitivity to oil and gasoline, their deficient colour retention, and their poor environmental compatibility. In the case of rehabilitation of the carriageway, the residues have to be disposed of as special waste.

If colour-marked paths are demanded—as is the case, for example, with bus lanes or cycle tracks—expensive coats of paint have to be applied, the coloration of which declines with time as a result of ageing, erosion and the action of light, so that the coat of paint has to be renewed, which again is costly.

In DE 196 05 990 A1 a ground surfacing is proposed consisting of a combination of broken natural stone and a polymerising liquid. The colouring of the surfacing is effected through an appropriate choice of the natural stone. However, this ground surfacing also loses its colour intensity if the superficial stones are worn down by reason of the abrasion of the carriageway in the event of high traffic loading of the carriageway. The same problems also hold true with regard to the ground surfacing disclosed in DE 20 2004 001 884 U1.

Surfacings having a uniform and visually appealing surface structure are known from DE 20 2004 001 884 U1. The water-pervious surfacing is produced from mineral aggregates and organic adhesives. The mixture is applied in the not yet cured, deformable state. An adhesive, which may be an organic adhesive, is mixed together with mineral aggregates so as to form a charge, and is processed prior to curing.

Against this background, the object of the invention is to specify a generic ground surfacing that withstands high mechanical loadings and is capable of being visually delimited in relation to adjacent developments.

In accordance with the invention, the object as stated with regard to the ground surfacing is achieved by means of the features of Claim 1.

In this connection the superstructure of the ground surfacing is constituted by a combination of compacted, solid aggregates and organic adhesives, the construction material of the aggregates exhibiting at least a predominant portion consisting of glass, and the adhesive being provided with a dyestuff. By virtue of the light-conducting property of the glass particles of the combination, the coloration of the adhesive is always passed on from glass particle to glass particle right up to the surface, so that the coloration remains discernible even when the glass particles have been worn down or the adhesive is superficially soiled or clouded over. As a result, a lasting colour retention is guaranteed even in the event of abrasion of the surface. The ground surfacing therefore durably retains its appealing or signalling coloration.

The loadings acting dynamically that arise from the rolling traffic, and the traffic forces, predominately acting statically, arising from the stationary traffic, bring about compressive, tensile and shearing stresses in the surfacing of the carriageway. The superstructure of the carriageway absorbs these stresses and distributes them harmlessly to the lower-level layers. The high compression resistance of the construction material makes it particularly suitable for the formation of carriageways. The proof of the compressive strength is adduced as follows:

The determination of the compression strength was carried out in accordance with DGGT Recommendation No. 1 in the form of a uniaxial compression test in respect of a prismatic sample. The prismatic samples had the dimensions 40 mm×40 mm×160 mm and led to the following result:

| | Compression | Tensile bending |
|---|---|---|
| | strength | strength |
| Sample material | [N/mm²] | [N/mm²] |
| Epoxy resin 10% with 90% | 40 | 16 |
| glass about 0.1-3 mm | | |
| Epoxy resin 10% with 90% | 32 | 14 |
| glass about 0.1-3 mm with | | |
| short-cut fibres | | |
| Polyurethane 10% with 90% | 30 | 15 |
| glass about 0.1-3 mm | | |
| Polyurethane 10% with 90% | 25 | 12 |
| glass about 0.1-3 mm with | | |
| short-cut fibres | | |

In this test the ground surfacing proved to be highly resistant to sustained loading, even in the event of the action of heat. The aforementioned values can be achieved both with glass beads and with broken glass or with a mixture thereof for the aggregate.

The open-pore structure of the superstructure, in particular in the case where use is made of broken glass, results in high coefficients of friction on the surface, so that the ground surfacing is particularly suitable by way of non-skid road surface for carriageways, pavements, steps and presentation spaces, and hence reduces the risk of accidents. A further improvement in the abrasion resistance can be achieved by admixing short-cut fibres made of glass.

The grain size of the aggregates also has a significant influence on the infiltration capacity of the ground surfacing. Particularly preferred are aggregates having an average grain size between 1 mm and 7 mm. As mentioned previously, the layered structure, according to the invention, of the ground surfacing has a favourable influence on the mechanical strength values, so that even values of over 5 mm for the average size of the grain are possible without a significantly increased risk of fracture arising. With this grain diameter the infiltration capacity can be increased further. Moreover, with these values the decline in the infiltration capacity over time as a result of introduction of mineral and organic fine materials remains slight.

In the course of a test following the model of DIN 18 035-6, Sections 5.6.3 and 5.1.6.2, the water-absorption values of the ground surfacing were ascertained and compared with the values of a conventional water-pervious sports ground. In this test the requirements of DIN 18 035-6 were exceeded by a multiple factor. For instance, a sample having a layer thickness dₒ of the superstructure amounting to 47 mm yielded a water-absorption value k*=0.51 cm/s. The requirement according to DIN 18 035-6, Table 3, amounts to >0.01 cm/s.

The grain size of the gravel in the substructure has a further favourable influence on the water-absorption value and water-regulation capacity of the ground. In the case of a mean grain size for the undersize grain amounting to 5 mm or more, this gravel promises excellent values. Proven average grain sizes g_{gravel} of the gravel lie within a range from 5 mm to 16 mm, 16 mm to 22 mm or 16 mm to 32 mm. That is to say, the gravel layer is composed of gravel having varying grain sizes, with the grain of a layer of crushed stone lying within one of the stated ranges.

The grain-size distribution is generally defined in accordance with DIN 66145. The parameter n amounts to at least 9 and is ascertained by disregarding 1% oversize grain and 1% undersize grain.

The adhesive is preferentially a two-component polyurethane adhesive. Use may also be made of a two-component epoxy-resin adhesive or a one-component polyurethane adhesive. Polyurethane adhesives are distinguished by total resistance to UV light, whereas epoxy-resin adhesives exhibit a high adhesive capacity, particularly on asphalt. Suitable adhesives are on offer, for example, from TerraElast AG, which has developed adhesive systems that are specialised for the particular application.

A significant advantage in the case where use is made of a two-component epoxy-resin adhesive is seen in its environmental compatibility. The ground surfacing according to the invention has, for example, no toxic effect whatsoever on mould fungi and is regarded as difficult to degrade microbially. Nevertheless, substances that are capable of being eluted from the ground surfacing can be degraded well, as material tests have shown. As washing tests prove, there is no chemical interaction between surface water and the surfacing materials, so that surface water that seeps through the surfacing can be introduced in the untreated state into the sewerage system or can run off harmlessly into the ground water. Lastly, after its utilisation phase the ground surfacing according to the invention can be disposed of in a ground washing plant or crushed-stone washing plant without negative environmental effects. Alternatively, after breaking-up or comminution, the ground surfacing may be re-used in the form of granulate.

Advantageous embodiments relating to the ground surfacing are evident from Claims 2 to 12.

With regard to the carriageway, the object consists in specifying a generic carriageway that can be applied onto existing carriageway surfacings and is capable of being delimited in terms of colour, in which connection a good fatigue strength is to be afforded.

In accordance with the invention, the object as stated with regard to the carriageway is achieved by means of the features of Claim 13 or 17.

In the case of the carriageway according to Claim 13, the superstructure exhibits a first ground surfacing and a strip consisting of a second ground surfacing that is different from the first ground surfacing. The strip is introduced in a depression in the first ground surfacing which is extended in the longitudinal and transverse directions of the carriageway. The ground surfacing is applied on a foundation and exhibits a multilayered structure, consisting of a superstructure and a substructure, the superstructure consisting of a combination of glass particles and organic adhesives, and the adhesive being provided with a dyestuff.

The carriageway is distinguished by a high load-bearing capacity, with high abrasion strength. In addition, the carriageway can be applied with little effort onto existing carriageway surfacings consisting, for example, of asphalt or concrete, in which case the combination, and in particular the adhesive, adheres durably to the old carriageway. The covering of the old carriageway surfacing is relieved of the temperature peaks, which particularly in the case of asphalt surfacings has the consequence that, in the event of traffic loading, deformations—such as ruts, for example—are less likely to occur.

The adhesive tensile strength of a ground surfacing consisting of asphalt according to the invention can be determined by a material test following the model of DIN EN 1015-12:200. To this end, an asphalt plate having the dimensions 26 cm×32 cm×4 cm is coated with the ground surfacing. To be specific, the ground surfacing according to the invention is applied onto an asphalt plate in a thickness of 4 cm. Prior to the tests, the samples have to be stored for around two weeks at room temperature. Prior to the test, the test areas are predrilled to a depth of about 45 mm, and test stamps are glued on with a two-component adhesive, trade name Metallix. In the case of a drilled depth of 45 mm the superficial ground surfacing has been completely drilled through, and the asphalt layer situated underneath has also been drilled into.

Suitable by way of test instrument is an adhesive-strength test instrument manufactured by Freundl of type F-15-D EASY, quality class 1. The following table reproduces the test values ascertained:

| | | | Adhesive | Fracture | |
|---|---|---|---|---|---|
| | Diam- | Test | tensile | pattern acc. | Pro- |
| | eter | area | strength | to DIN | portion |
| No. | [mm] | [mm²] | [N/mm²] | 18555-6 | in % |
| Polyurethane 1 | 50 | 1963.5 | 0.42 | a | 100 |
| Polyurethane 2 | | | 0.35 | a | 100 |
| Polyurethane 3 | | | 0.36 | a | 100 |
| Mean value | | | 0.38 | a | 100 |
| Set value | | | ≧0.2⁽¹⁾/0.5⁽²⁾ | — | — |

If the carriageway is to be capable of being visually delimited in relation to the surrounding development or, where appropriate, in relation to the adjoining carriageway surfacing, the carriageway—such as, for example, for bus lanes or cycle tracks—can be applied in a strip onto an existing carriageway, in which case, as a rule, a certain height, a few cm, is removed from the carriageway surfacing by milling and the strip is applied thereon.

The granulation of the aggregates is chosen to be such that the carriageway surfacing of the strip is impervious to water. By this means, it is ensured that the strip which is enclosed at the edges by the old carriageway surfacing is not filled with surface water in the event of precipitation, which in the case of frost could result in an erosion as a result of the frozen regions bursting open.

It is advantageous to realise the superstructure in multiple layers, so that the upper, thinner layer consisting of the somewhat more expensive but abrasion-resistant polyurethane adhesive and the lower layer on the old-carriageway side is thicker and exhibits a bond with epoxy-resin adhesive. The latter is distinguished by good adhesion on asphalt. In one embodiment, in which in cost-effective manner the more resistant ‘glass’ layer is positioned at the very top and the layer situated beneath it consists of an inexpensive combination of mineral aggregates consisting of granite, basalt or quartzite and of an epoxy-resin adhesive, the layer thicknesses amount to 1 cm and 3 cm, respectively. The layer-thickness ratio V of the ground surfacing to the further layers of the superstructure preferentially amounts to 0.5 or less.

It is an advantage to enclose the strip with a joint which is filled in elastically. By this means, the surfacing of the strip is able to expand in strain-free manner in relation to the surrounding old surfacing, as is the case in the event of heating, when subject to insolation for example.

Further advantageous embodiments relating to the carriageway will become evident from Claims 14 to 16 and 18 to 21.

Advantageous embodiments of the invention will be elucidated in the following with reference to the appended drawing. Shown are:

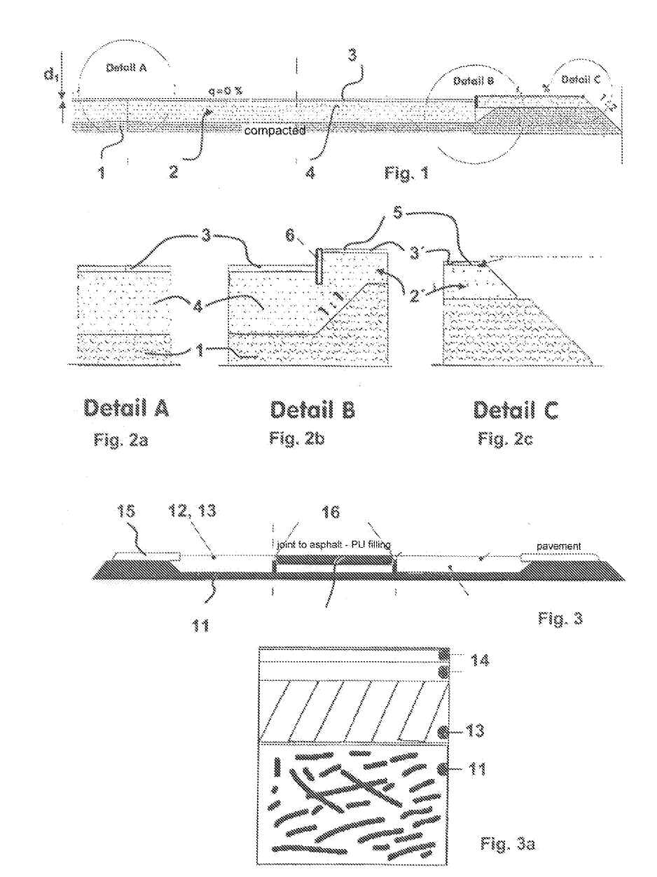

FIG. 1 a typical cross-section of a carriageway,

FIG. 2a a detail according to Detail A in the central region of the carriageway,

FIG. 2b a detail according to Detail B in the marginal region of the carriageway,

FIG. 2c a detail according to Detail C in the pavement region of the carriageway,

FIG. 3 a typical cross-section of an old carriageway with bus lane introduced and

FIG. 3a a detail according to Detail A in the region of the bus lane.

FIG. 1 shows the structure of a road. Said structure is subdivided into the foundation, the substructure 1 and the superstructure 2. The superstructure 2 is crucial for the load-bearing capacity due to traffic loads. The foundation and the substructure 1 have therefore been developed so as to be correspondingly load-bearing. In the case of the foundation, which is not represented in any detail, it is a question of the ground that is naturally in situ. It serves as a base for the substructure 1 and the superstructure 2. In order to increase the load-bearing capacity of the substructure 1, the latter is consolidated.

The superstructure 2 of the carriageway is realised in multiple layers and exhibits by way of road surface and first layer 3 a hardened combination of glass particles and an organic, dyed adhesive, a polyurethane adhesive. In the case of the glass particles, it is a question of a mixture of glass beads and broken glass. The layer thickness d₁ amounts to 6 cm.

The granulation of the aggregates has a grain-size distribution with an average size d_{K} of the grain within a range from 3 mm to 7 mm, and is consequently pervious to water.

In the case of layer 4 of the superstructure 2, which is situated underneath, this is a 75 cm thick layer of crushed gravel with a granulation of 11/22 which is bound with an organic adhesive. As FIG. 2a shows, this second layer 4 is built up in several layers, the gravel being bound in each instance by spraying on adhesive. The substructure 1 situated underneath is constituted predominantly by a 35 cm thick compacted layer of antifreeze gravel. The substructure rests, in turn, on the rough formation of the foundation which is not represented in any detail.

As FIGS. 2b and 2c show in detail, the road exhibits a pavement 5 on each of its two sides. Said pavement is realised in raised manner in relation to the carriageway. The step between the carriageway and the pavement is formed from a strip-like prefabricated component 6 consisting of a combination of solid or mineral aggregates and an organic adhesive. The prefabricated component terminates flush with the surface of the pavement 5 and extends into the second layer on the carriageway side.

In the region of the pavement 5 the superstructure 2′ is likewise multilayered, though of thinner construction, and exhibits by way of road surface and first layer 3′ a hardened combination of glass particles and an organic, dyed adhesive. The glass particles may be a mixture of glass beads and broken glass. The layer thickness d₂ amounts to 4 cm.

The granulation of the aggregates has a grain-size distribution with an average size d_{K} of the grain within a range from 3 mm to 7 mm, and is consequently pervious to water.

In the case of layer 4′ of the superstructure 2′, which is situated underneath, it is a question of a 35 m thick layer consisting of crushed gravel with granulation 11/22, which is bound with an organic adhesive. As FIGS. 2a and 2b show, this second layer 4′ is built up in several layers, the gravel being bound in each instance by spraying on adhesive. The substructure 1′ situated underneath is constituted predominantly by a 100 cm thick, compacted layer of antifreeze gravel. The substructure 1′ rests, in turn, on the rough formation of the foundation which is not represented in any detail.

In the case of the road shown in FIGS. 3 and 3a, it is a question of a heavy-load road with a pavement 15 and with a centrally inserted bus lane. The road exhibits a substructure and a superstructure 11 and 12, respectively, the substructure 11 being made up as in the embodiment previously described. The superstructure 12 exhibits a first ground surfacing 13 consisting of mastic asphalt. Into this first ground surfacing 13 a strip 14 has been sunk in the centre of the carriageway, said strip being filled up with a multilayered ground surfacing. The thickness of the strip 14 or of the multilayered ground surfacing amounts to 4 cm.

The multilayered ground surfacing consists of a superficial first layer consisting of a hardened combination of glass particles and an organic, dyed adhesive. In the case of the glass particles, it is a question of a mixture of glass beads and broken glass. The following grading curve is exhibited by the aggregates:
0.1 mm-0.8 mm 30%,
0.8 mm-1.8 mm 40% and

1.8 mm-2.4 mm 30%.

Alternatively, the following grading curve applies:
0.1 mm-0.8 mm 35%,
0.8 mm-1.8 mm 30% and
1.8 mm-2.4 mm 33%.

The proportion of adhesive amounts to min. 10%, in order to guarantee the imperviousness to water. Hence the bus lane is prevented from being filled to overflowing with surface water. For if ground that contains water freezes, ice lenses arise at the frost line, which result in a heaving of the ground. Under traffic loading, said ice lenses break up; frost damage occurs.

The second layer, situated underneath, is realised from a combination of mineral aggregates and an epoxy-resin adhesive. Granite, basalt, quartzite etc are used for the aggregates. The granulation lies within the following ranges: 1-3 mm, 2-5 mm, 3-7 mm, and is bound with a proportion of epoxy resin amounting to 2-5%, depending on the grain size.

The strip 14 is delimited in relation to the first ground surfacing 13 adjoining laterally in each instance by means of a joint 16 which is filled in elastically.

### List of Reference Symbols

1, 1′, 11 substructure

2, 2′, 12 superstructure

3, 3′ first layer

4, 4′ second layer

5, 15 pavement

6 prefabricated component

13 first ground surfacing

14 strip

16 joint

layer thickness d₁

layer thickness d₂

average size d_{K}

aggregates k_{Z}

1. A ground surfacing for carriageways and paths, to be applied onto a foundation with a multilayered structure, comprising:
a superstructure; and
a substructure,
the superstructure of the ground surfacing being a combination of compacted, solid aggregates and organic adhesives,
a construction material of the solid aggregates comprising at least a predominant proportion of glass beads, and the organic adhesives comprising a dyestuff.

2. The ground surfacing according to claim 1, wherein the solid aggregates comprise broken glass.

3. The ground surfacing according to claim 1, wherein a granulation of the solid aggregates k_{Z} lies within a range from 0.1 mm to 3 mm.

4. The ground surfacing according to claim 1, wherein the solid aggregates comprise a grain-size distribution with an average size dₖ of the grain lying within one of a range from 1 mm to 3 mm, a range from 2 mm to 3 mm, a range from 2 mm to 4 mm, a range from 2 mm to 5 mm, and a range from 3 mm to 7 mm.

5. The ground surfacing according to claim 1, wherein a compression strength of the ground surfacing is at least 25 N/mm².

6. The ground surfacing according to claim 1, wherein a tensile bending strength of the ground surfacing is at least 12 N/mm².

7. The ground surfacing according to claim 1, wherein the organic adhesives are selected from the group consisting of a two-component epoxy resin, a one-component polyurethane adhesive, and a two-component polyurethane adhesive.

8. The ground surfacing according to claim 1, wherein a mass proportion of the organic adhesives is about 10%.

9. The ground surfacing according to claim 1, wherein a mass proportion of the solid aggregates is about 90%.

10. The ground surfacing according to claim 1, wherein the solid aggregates comprise a proportion of fibrous materials.

11. The ground surfacing according to claim 1, wherein a granulation of the solid aggregates is chosen to be such that the ground surfacing is impervious to water.

12. The ground surfacing according to claim 1, wherein a granulation of the solid aggregates is chosen to be such that the ground surfacing is pervious to water.

13. A carriageway with a superstructure and a substructure, which have been applied on a foundation, the superstructure comprising:
a first ground surfacing; and
a strip consisting of a second ground surfacing that is different from the first ground surfacing,
the strip being inserted in a depression in the first ground surfacing which extends along longitudinal and transverse directions of the carriageway,
the second ground surfacing being made in accordance with claim 1.

14. The carriageway according to claim 13, wherein the superstructure in a region of the strip is made in at least three layers, the at least three layers comprising: a superficial first layer being made from the second ground surfacing, a second layer located underneath being made from a non-dyed ground surfacing, and a third layer being made from the first ground surfacing.

15. The carriageway according to claim 13, wherein a construction material of the first ground surfacing is made of one of asphalt and concrete.

16. The carriageway according to claim 13, wherein the strip is delimited with respect to a laterally adjoining first ground surfacing by an elastically joint.

17. A carriageway comprising:
a superstructure; and
a substructure, which are applied on a foundation,
the superstructure being made in multiple layers, and
at least a superficial ground surfacing thereof being made in accordance with claim 1.

18. A carriageway according to claim 17, wherein a construction material of at least one layer of the superstructure located beneath the superficial ground surfacing is made from one of asphalt and concrete.

19. A carriageway according to claim 17, wherein a construction material of at least one layer located beneath the superficial ground surfacing is a combination of an organic adhesive and compacted gravel, wherein an average size gravel of an undersize grain being at least 5 mm.

20. A carriageway according to claim 17, wherein a layer-thickness ratio V of the superficial ground surfacing to further layers of the superstructure is at most 0.5.

21. A carriageway according to claim 14, wherein the layers of the superstructure are bonded to one another by adhesive bonding.
